(19) United States
(12) Patent Application Publication
(10) Pub. No.: US 2024/0231893 A1
(43) Pub. Date: Jul. 11, 2024

(54) AI-ASSISTED CONTEXT-AWARE PIPELINE CREATION

(71) Applicant: Intel Corporation, Santa Clara, CA (US)

(72) Inventors: Richard Chuang, Chandler, AZ (US); Yu Zhang, Beijing (CN)

(73) Assignee: Intel Corporation, Santa Clara, CA (US)

(21) Appl. No.: 18/570,912

(22) PCT Filed: Nov. 19, 2021
(86) PCT No.: PCT/CN2021/131643

§ 371 Date: Dec. 15, 2023

(51) Int. Cl. G06F 9/48; G06F 40/284

(52) U.S. Cl. CPC G06F 9/485; G06F 40/284

(57) ABSTRACT

AI-assisted pipeline copilot techniques are described herein. In one example, a workflow method using an AI-assisted pipeline copilot involves receiving pipeline information from a user for an artificial intelligence (AI) pipeline and identifying key words in the pipeline information. A recommended next task component to add to the AI pipeline is then determined using a neural network model based on: a mapping of the key words to AI pipeline stages and one or more previous task components added to the AI pipeline. Connections between the recommended next task and the existing pipeline can also be inferred with a second neural network model. The recommended next task components and connections can then be provided to the user (e.g., with a graphical user interface).

### RELATED APPLICATION

This application is a U.S. National Phase application under 35 U.S.C. § 371 of International Application No. PCT/CN2021/131643 filed Nov. 19, 2021, entitled “Artificial Intelligence (AI)-Assisted Context-Aware Pipeline Creation,” the entire contents of which are incorporated herein by reference.

### FIELD

This disclosure relates generally to artificial intelligence and some examples relate more particularly to artificial intelligence (AI)-assisted pipeline creation.

### BACKGROUND OF THE DISCLOSURE

The complexity of real-world AI and analytic solutions is growing fast to meet the requirements of targeted applications and use cases. To master the full stack of software development skills, developers typically need to comprehend a large set of knowledge. It can take many years of experience dealing with different generations of target platforms to perfect the skill of making a good AI application.

Therefore, the learning cost for developers to enter the AI solution space is high. Once developers have become familiar with a preferred development environment, switching the developers to another platform can be difficult. Even if a code conversion tool is provided to the developers, the transition to another platform can still be difficult due to the time required to become familiar with the new platform.

### BRIEF DESCRIPTION OF THE DRAWINGS

So that the manner in which the features of the present embodiments can be understood in detail, a more particular description of the embodiments. briefly summarized above. may be had by reference to embodiments, some of which are illustrated in the appended drawings. It is to be noted, however, that the appended drawings illustrate only typical embodiments and are therefore not to be considered limiting of its scope.

FIG. 1A is a block diagram of an example of a software stack for implementing techniques described herein.

FIG. 1B is a block diagram of an AI-assisted pipeline tool.

FIG. 1C illustrates an example of a project or pipeline profile.

FIG. 2 illustrates an example of topic strength.

FIG. 3 illustrates an example of a matrix that maps key words to AI pipeline stages.

FIG. 4 is an example of an abstraction graph associating key words from the project description with pipeline stages.

FIGS. 5 and 6 illustrate an input and output of the component predictor model.

FIG. 7 illustrates an example of output of a connection predictor model.

FIG. 8 illustrates a flow diagram of an AI-assisted pipeline workflow including the models and parameters of FIGS. 2-7.

FIGS. 9A and 9B are block diagrams of examples of task components.

FIG. 9C is an example of a graphical user interface displaying recommended next task components.

FIG. 9D is an example of a graphical user interface displaying a pipeline after the next task component is selected.

FIG. 10 is a flow chart of an example of a runtime workflow method using an AI-assisted pipeline copilot.

FIG. 11 is a block diagram of an example of the runtime workflow of FIG. 10.

FIG. 12 is a flow chart of an example of a training method for models of an AI-assisted pipeline copilot.

FIG. 13 is a block diagram of an example of the training method FIG. 12.

FIG. 14 depicts a compute platform such as a server or similar computing system in which techniques described herein may be implemented.

### DETAILED DESCRIPTION

Artificial Intelligence (AI)-assisted context aware pipeline creation is described herein.

Artificial intelligence solutions have become increasingly complex. The complexity of the AI solution space has resulted in a significant learning cost for developers. Developers are typically expected to understand details such as the nature of the problems, the application programming interface (API) and data flow to be used in the applications, the software development kits (SDKs) and documentation of different layers of the stack, etc. Additionally, developers face the same learning curve when switching to a new AI platform.

Some tools attempt to address this problem by providing assistance to developers at the coding level. For example, some tools suggest individual lines of code based on the context described in the nearest lines of codes, comments, or in the function names. For example, code assistant tools can suggest a few lines of code for users to adopt and modify to accelerate program development. Therefore, developers can save their time from typing frequently used code.

However, the support provided by code assistant technologies is at the coding level. Such code assistance tools only help developers become embedded deeper in the development environment of such a platform. Furthermore, with code assistance tools, the developers still need to have good knowledge about the functions and key ingredients, libraries, and APIs to adjust the code templates suggested by the tool to achieve the desired functionality. Also, optimization of the code logic is still a manual process. Code optimization in existing tools requires a significant amount of learning and training to improve the whole AI application and data workflow.

In contrast, an AI-assisted pipeline copilot provides a graphical interface (instead of a coding interface) for developers to construct their AI applications and workflow at the pipeline level by connecting key AI analytics, data, and IO functions to form a complete workflow. In one example, a workflow method using an AI-assisted pipeline copilot involves receiving pipeline information from a user for an artificial intelligence (AI) pipeline and identifying key words in the pipeline information. A recommended next task component to add to the AI pipeline is then determined using a neural network model based on a mapping of the key words to AI pipeline stages and one or more previous task components added to the AI pipeline. Connections between the recommended next task and the existing pipeline can also be inferred with a second neural network model. The recommended next task components and connections can then be provided to the user (e.g., with a graphical user interface).

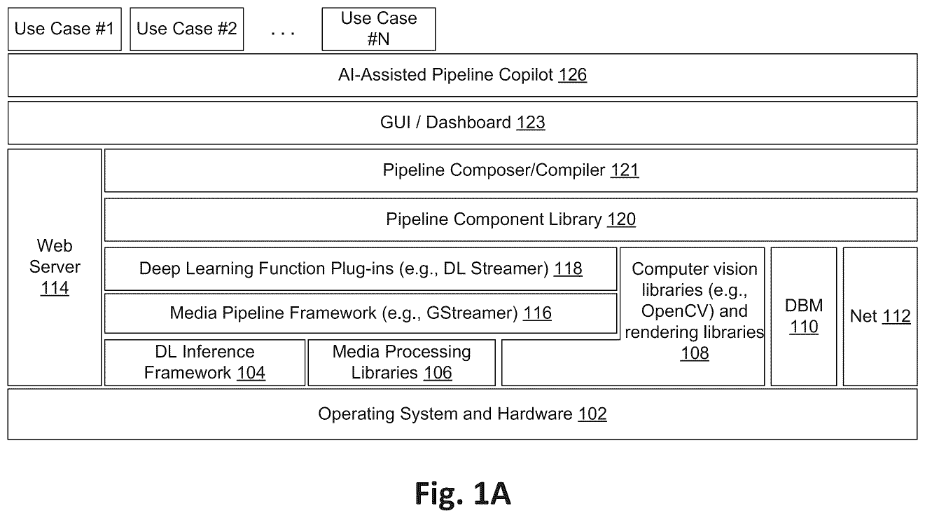

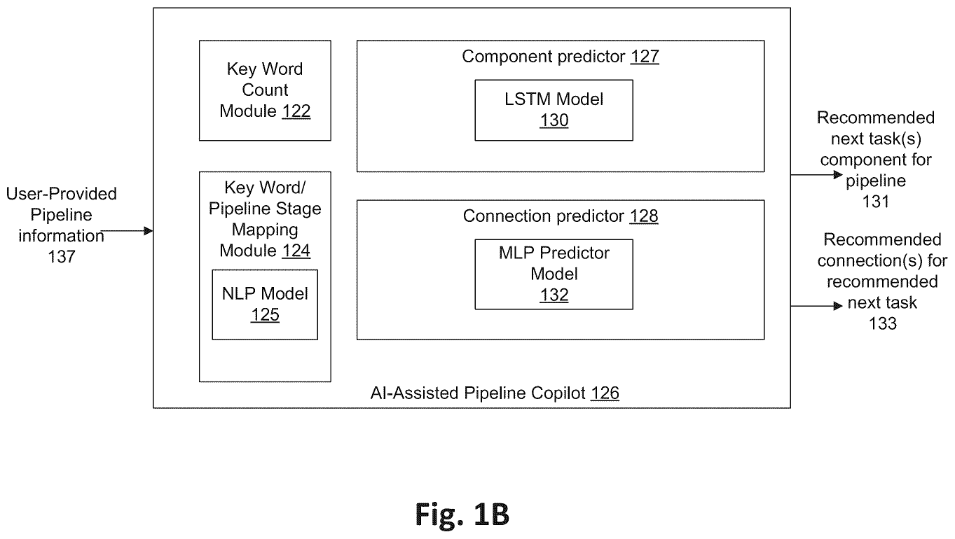

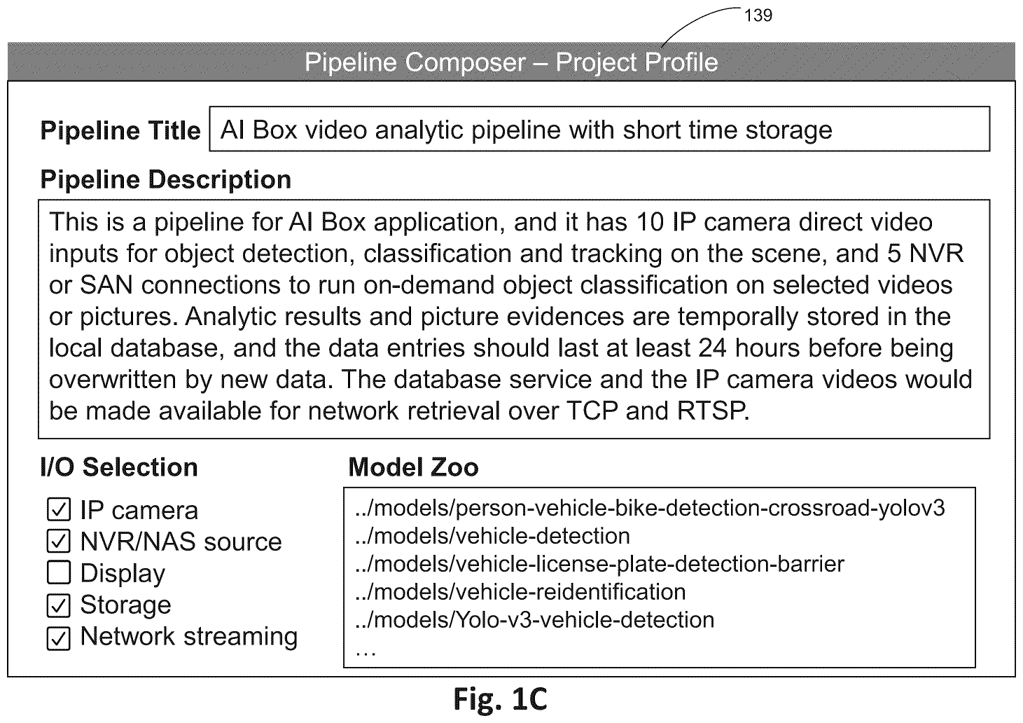

FIG. 1A is a block diagram of an example of a software stack for implementing techniques described herein.

The stack includes an operating system 102 running on hardware (e.g., stored in system memory and executed by one or more processor cores). For example, the operating system may include or support drivers or applications for hosting a web server 114 and accessing a network 112. In one example, the operating system 102 is a Microsoft® Windows® operating system from the Microsoft Corporation, a proprietary UNIX-like operating system, an open-source UNIX-like operating system using a variant of the Linux kernel, or other operating system.

In one example, the operating system 102 provides a software platform for execution of applications. For example, the operating system 102 and/or drivers may provide support for libraries and frameworks such as a deep learning inference framework 104 (e.g., OpenVINOR) by Intel® Corporation), media processing libraries 106 (e.g., Media SDK and OneVPL by Intel® Corporation), computer vision and rendering libraries 108 (e.g., Open Source Computer Vision Library (OpenCV)), media pipeline framework 116 (e.g., Gstreamer and FFMPEG), deep learning function plug-ins 118 (e.g., DL Streamer), DBM 110, and a pipeline component library 120.

The pipeline component library 120 defines the function, data flow, and data format of specific tasks that may be included in an AI pipeline. An AI pipeline is a data process flow for an AI application that consists of pipeline stages, each stage including one or more modules or task components. In one example, each module or task component is a high level block that a pipeline composer/compiler 121 converts into modules of code that can be compiled into an executable. Examples of pipeline task components include: data ingestion (e.g., video/image ingestion), decoding/reconstruction, pre-processing (e.g., resize, crop, color space transformation, or other pre-processing), deep learning inferencing, video/image post-processing (bonding boxes overlay on the original video/image), metadata/video output, detection, classification, tracking. post-processing, encoding, file systems, database, network services, and other AI pipeline task components. Thus, in one example, an AI pipeline includes a sequence of tasks to create an AI application or solution. As an example, an AI pipeline use case may include: 4×IP camera inputs→video decoding→video frame resize→color code transform→AI detection (object, people, smoke, etc.)→metadata output via MQTT, video output via RTSP.

In addition to a pipeline component library 120, the stack of FIG. 1A includes a pipeline composer or compiler 121. In one example, the pipeline composer 121 is a compiler tool that can convert a pipeline (e.g., an AI pipeline) represented in a graph to syntax. A graphical user interface (GUI) or dashboard 123 provides an interface to the user for creating an

AI pipeline by selecting. dragging-and-dropping components, or otherwise manipulating graphical elements with a human interface device such as a keyboard, mouse, touchpad, or other interface device to form an AI pipeline.

The stack of FIG. 1A also includes an AI-assisted pipeline tool or copilot 126. The AI-assisted pipeline tool sits on top of the stack and can analyze the information associated with a use case (UC) and determine what are the most relevant next task components for the AI pipeline. A use case is a particular use or project including a pipeline and associated project or pipeline information. In one example, project information includes one or more of: title or the project or pipeline, description of the project or pipeline, and inputs and outputs (I/Os) to be included in the pipeline. In addition to user-provided pipeline information, the AI-assisted pipeline copilot 126 determines the next most relevant task components based on parameters and data links between components in existing pipelines.

FIG. 1B is a block diagram of the AI-assisted pipeline copilot 126. The AI-assisted pipeline copilot 126 receives input 137 from a user including information about the pipeline to be created. Based on the pipeline information and task components that were previously added to the pipeline, trained models infer the next best task components 131 to recommend to the user and connections 133 for the next task components. In the example of FIG. 1B, the AI-assisted pipeline copilot 126 includes a key word count module or function 122 to count key words identified in the user-provided pipeline information 137. For example, the keyword count module 122 may include an empirical method (e.g., word2count or other method) that converts words in the pipeline information into keyword counts. In one example, the key word count module 122 identifies key words based on a reference list of keywords. The count of the keywords can then be used to determine keyword or “topic” strengths or weights. In one example, the keyword count module 122 assigns weights (e.g., normalized weights) to the identified keywords based on keyword count. Other information can also be considered in assigning weights to keywords in addition to, or alternatively to, keyword counts. For example, the location of the keyword (e.g., in the title or the description, or location in the description), or other contextual information may also be used in assigning weights.

In addition to determining topic strengths from the user-provided pipeline information 137, the AI-assisted pipeline copilot 126 includes a key word mapping module 124 that maps identified key words to AI pipeline stages. In one example, the key word mapping module includes a natural language processing (NLP) model 125 to link or map each of the keywords to a pipeline stage. Each stage of the pipeline (e.g., input, analytics, display, storage, network, etc.) has a set of task components associated with the given stage. Additional information around the keywords (e.g., other words in the same sentence) can also be extracted from the pipeline information with the NLP model and associated with the keyword and pipeline stage.

The AI-assisted pipeline copilot 126 includes two artificial neural network models: a long short-term memory (LSTM) model 130 of the component predictor 127 to infer the next best task component to recommend, and a multilayer perceptron (MLP) model 132 of the connection predictor 128 to infer the best connection 133 to recommend for connecting the next task component with previously added task components. The LSTM model 130 could also be referred to as component relevance estimator that estimates the relevance of task components based on the keyword weights and mapping and previously added task components. In one example, the LSTM predictor model 130 is a time-sequence analytic and prediction model, which associates the existing pipeline information with the context of the project and predicts the next task components that are most likely to be used according to the training data (e.g., existing projects and their pipelines).

In one example, the MLP predictor model 132 is a prediction model used to predict the connection strength between parent (e.g., previously added) and newly suggested task components. The MLP model 132 could be referred to as a connectivity relevance estimator that estimates the relevance of connecting the input and output of the recommended task components to existing task components in the pipeline. The MLP model 132 is trained by existing connection info between all task components in projects and pipelines collected in a training database. The recommended next tasks 131 and connections 133 can be displayed to the user with a graphical user interface to enable the user to select a recommended task and connection to the existing task components in the pipeline.

Thus, the AI-assisted pipeline copilot integrates AI and ML/NLP algorithms to understand the nature of the pipeline design. Based on the scope and ongoing project development, AI inference is used to assist developers by prompting users with the most relevant functional blocks on a graphical interface to select and use. The AI-assisted pipeline copilot can help users build a complete pipeline workflow without being trained programmers and without reading through libraries and API documentation.

FIG. 1C illustrates an example of a project or pipeline profile provided by a user. The project profile of FIG. 1C is illustrated as a window 139 in a graphical user interface. The window 139 includes input elements, such as text boxes and check boxes with which a user may specify pipeline information. Other graphical input elements may also or alternatively be used, such as drop-lists, radio buttons, or other graphical input elements.

The project profile of Figure IC includes a pipeline or project title and pipeline or project description. In one example, the pipeline title and pipeline description are natural language inputs provided by the user to describe the AI pipeline to be created. The pipeline profile of FIG. 1C also indicates an I/O Selection, which are inputs or outputs to be included in the AI pipeline. Examples of I/Os include: internet protocol (IP) camera, network video recorder (NVR) (e.g., NVR that records to a network-attached storage (NAS) device), display, storage, and network streaming. In the example of FIG. 1C, a model zoo is also provided to enable users to select particular models to use in the AI pipeline project. In one example, the model zoo is a configurable list or library of models to use in the pipeline creation.

As mentioned above with respect to FIG. 1B, the pipeline copilot 126 receives the user-provided pipeline information as input and determines keyword or topic strengths. Using the user-provided information of Figure IC as an example, the pipeline copilot can identify key words such as: AI Box, video, short time storage, IP camera, video, object detection, NVR, picture, database, TCP, RTSP. In one example, a key word counting module (e.g., the module 122 of FIG. 1B) counts the identified key words and assigns weights to the key words.

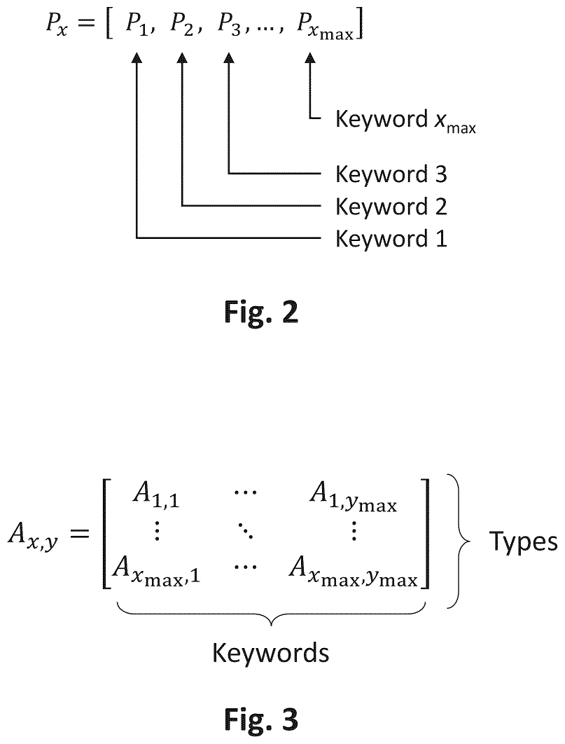

FIG. 2 illustrates an example of topic strength. Topic strength is represented by Pₓ, where x=1, 2, . . . , xₘₐₓ, and xₘₐₓ is the number of topic keywords predefined in the tool. In one example, the topic strength Pₓ is normalized so that the sum of all Pₓ=1. Therefore, the topic strengths of keywords are based on how many times a keyword is mentioned in the pipeline information relative to other keywords. For example, if “AI Box” is the only keyword mentioned in the pipeline information and “AI Box” is keyword 1, then Pₓ=[1, 0, 0, . . . 0]. In another example, if “AI Box” and “NVR” are each mentioned once, and “NVR” is keyword 3, then Pₓ=[0.5, 0, 0.5, . . . 0]. The keyword strengths may also be referred to as weights. The strengths Px of the keywords can then be used as input to the component relevance estimator to improve the probability of selecting a relevant next pipeline task component.

In addition to key word strengths, the AI-copilot considers the component's relevance to the current pipeline stage to infer the next task component. In one example, key words are mapped to stages of the AI pipeline. FIG. 3 illustrates an example of a matrix to map key words to AI pipeline stages. FIG. 3 depicts a matrix A_{x,y} with dimensions xₘₐₓ-by-yₘₐₓ, where xₘₐₓ is the number of pipeline stages defined in the pipeline copilot tool and yₘₐₓ is the number of topic keywords. In FIG. 3, “Types” refers to the pipeline stage (e.g., the input, analytics, etc.). Although FIG. 3 is depicted as a two-dimensional abstraction graph, the mapping of keywords to pipeline stages can be achieved with other structures. For example, another matrix or another dimension to the matrix Ax,y could be added to associate additional contextual information with the keywords and pipeline stages. For example, if “IP camera” is mapped to the input stage, the number of IP cameras (e.g., “10 IP cameras”) could be associated with the keyword with an additional matrix or dimension.

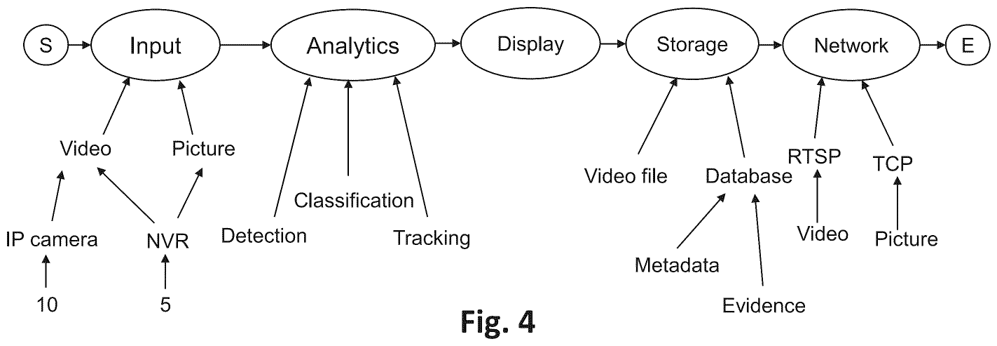

FIG. 4 is an example of an abstraction graph associating key words from the project description with pipeline stages. In one example, the graph focuses on the relationship between keywords that have been identified as key steps in the pipeline using Natural Language Processing (NLP) techniques. The NLP approach can be unsupervised (e.g., using word2vec, sent2vec, word counts, etc.) or supervised (LSTM, BILSTM, BIDAF, BiMPM, etc.). Here, the key task components and associated numbers are linked to each pipeline stage. Each stage of the pipeline (input, analytics, display, storage, and network) has a set of task modules associated with the given stage.

In the illustrated example, the available pipeline stages are: input, analytics, display, storage, and network. The pipeline of FIG. 4 is an example of a video pipeline: however, the AI-assisted copilot can assist with building other types of AI pipelines. As mentioned above, the AI-assisted pipeline copilot includes a natural language processing (NLP) model that is trained based on technical documents related to the video analytics and pipeline building documents to pull the abstraction and key words from a given description of the project and map or associate the key words with stages in the AI pipeline. The NLP used in the example of FIG. 4 is an unsupervised word2vec method to convert the project title and descriptions into the vectors between keywords and subjected stages (types) in a pipeline. The vectors can be represented in a graph to show the abstracts extracted from the text information. The association can have a graph representation, such as illustrated in FIG. 4. The key words can then be associated with task components or modules defined in the pipeline component library, and each task component can be associated directly with preselected models in the Model Zoo.

In the example illustrated in FIG. 4, “video”, “picture”, “IP camera”, and “NVR” are associated with or mapped to the input stage of the pipeline. The number “10” is associated with “IP camera”, and the number “5” is associated with “NVR”. Similarly, the keywords “detection”, “classification”, and “tracking” are associated with or mapped to the analytics stage of the pipeline. No keywords are mapped to the display stage of the pipeline. The keywords “video file” and “database” are associated with or mapped to the storage stage of the pipeline. The keywords “metadata” and “evidence” are associated with the keyword “database”. Finally, the keywords “RTSP” and “TCP” are mapped to the network stage of the pipeline. The keyword “video” is associated with “RTSP”, and the keyword “Picture” is associated with “TCP”. Thus, in the illustrated example, the key words are all mapped to or associated with one stage of the AI pipeline. Some keywords are (such as the numbers “10” and “5”) provide additional information about another keyword.

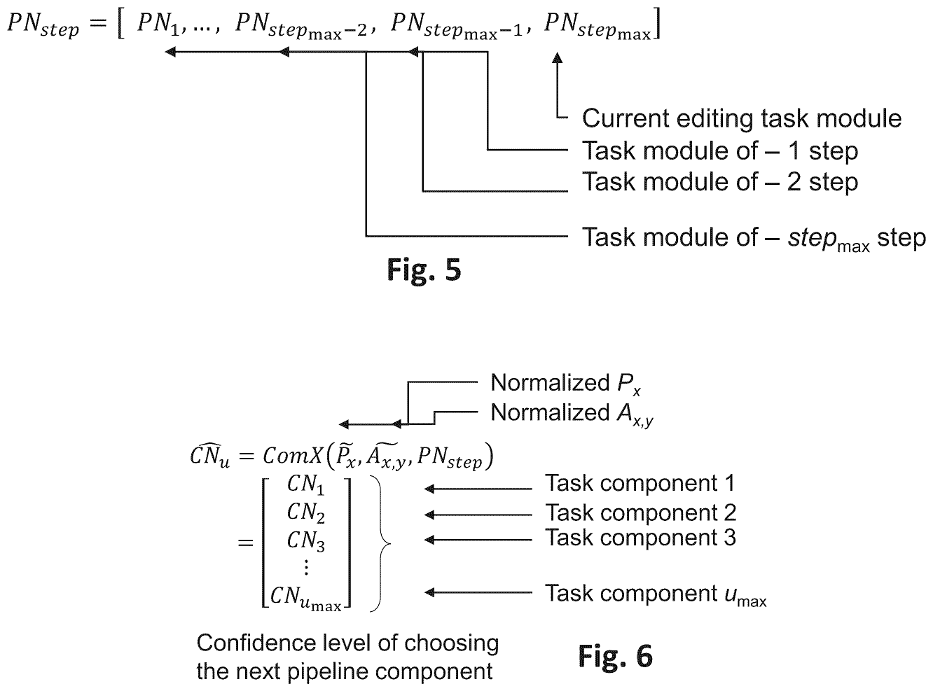

After computing keyword weights and mapping keywords to pipeline stages, one or more next best task components can be inferred based on the keyword weights, keyword mapping, and previously added task components. FIGS. 5 and 6 illustrate an input and output of the component predictor model (e.g., the LSTM model 130 of FIG. 1B). FIG. 5 illustrates PNstep, the previously added task components in the existing pipeline. The variable step is the number of previous task components used in the time-sequence deep learning analytic model (e.g., the LSTM model 130 of FIG. 1B), where step=1, 2, . . . , stepₘₐₓ, and stepₘₐₓ is the max number of steps to be considered in this time-series model.

FIG. 6 illustrates an example of output of a component predictor model, such as the LSTM model 130 of FIG. 1B. In one example, the component predictor model is an LSTM or time-sequence analytic model. In one such example, the component predictor model is defined to describe the confidence level of suggesting a new task component CN that is consequently to be recommended to a user given the topic relevance Pₓ, component relevance matrix A_{x,y}, and the previous task components PNₛₜₑₚ in the existing pipeline. In the illustrated example, Pₓ and A_{x,y} are normalized. The output of the component predictor model is represented by [symbol] , which is confidence levels for each recommended next task component. In the illustrated example, uₘₐₓ task components are provided to the user to select from, where uₘₐₓ is a positive integer in a range from 1 to the maximum number of task components available to the pipeline copilot tool.

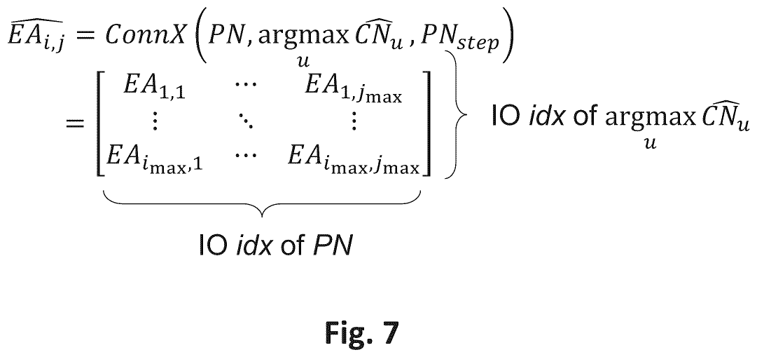

In addition to recommending one or more next task components, in one example, the copilot also provides a recommendation regarding how the recommended next task component will connect to the task components in the existing pipeline. FIG. 7 illustrates an example of output of a connection predictor model, such as the MLP predictor model 132 of FIG. 1B. As mentioned above, in one example, the connection predictor model is an MLP-based predictor. The predictor model determines the connection strength between parent and newly suggested task components, PN and CN. EA_{i,j} is the output of the connection predictor model. In the illustrated example, EA_{i,j} is a two-dimensional matrix that defines the connectivity strength of IO(i) of PN and IO(j) of CN, where i=1, 2, . . . , iₘₐₓ and j=1, 2, . . . jₘₐₓ. Assuming that the inputs and outputs of all task components are standardized (e.g., every task component has the same number of inputs and outputs), then iₘₐₓ would equal jₘₐₓ because all task components share the same IO properties. Note that in the example illustrated in FIG. 7, the input to the connection predictor is the argmax of [symbol] ; however, the model can be run for all CN, for a subset of CN, or only for a user-selected CN.

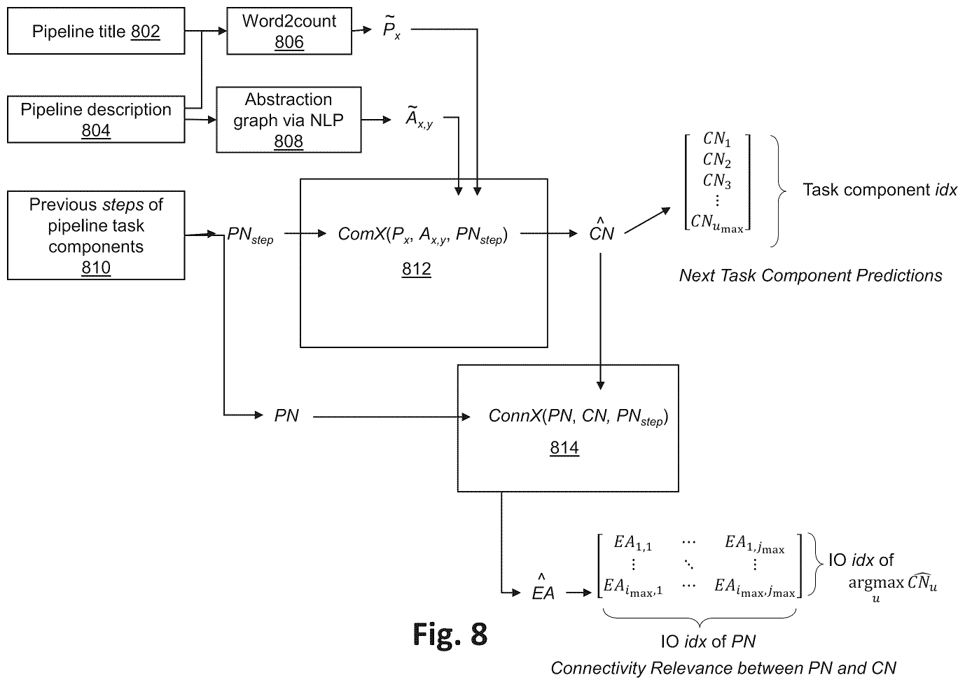

Thus, the copilot tool utilizes a classifier-level ensemble for multimodal sensor function to predict the best pipeline components to the users based on their project profiles and existing implementations. In one example, the AI-assisted pipeline copilot includes an NLP model to map keywords from the user-provided pipeline information, an LTSM-based predictor model to infer one or more next task components, and an MLP-based predictor model to infer connections between the inferred next task components and existing task components in the pipeline. The parameters and models in this multimodal analytic method can be orchestrated as a flow diagram as illustrated in FIG. 8.

In the example of FIG. 8, the pipeline title 802 and pipeline description 804 are

provided as inputs to the word2count block 806 to generate keyword weights [symbol] and to the NLP model 808 to generate an abstraction graph [symbol] . The keyword weights and abstraction graph are provided as input to the LTSM-based model 812. The previous steps of pipeline task components 810 are also provided to the LTSM-based model 812. The LTSM-based predictor, with predetermined steps and classifier-level fusion, generates next task component predictions [symbol] . The next task component predictions [symbol] and the previous steps of pipeline task components 810 are provided as input to the MLP-based predictor model 814. The MLP-based predictor model 814 generates connectivity relevance between PN and CN, which is represented as the matrix [symbol] . The AI-assisted pipeline copilot can then provide a recommendation of the next task component and its connectivity with a graphical user interface.

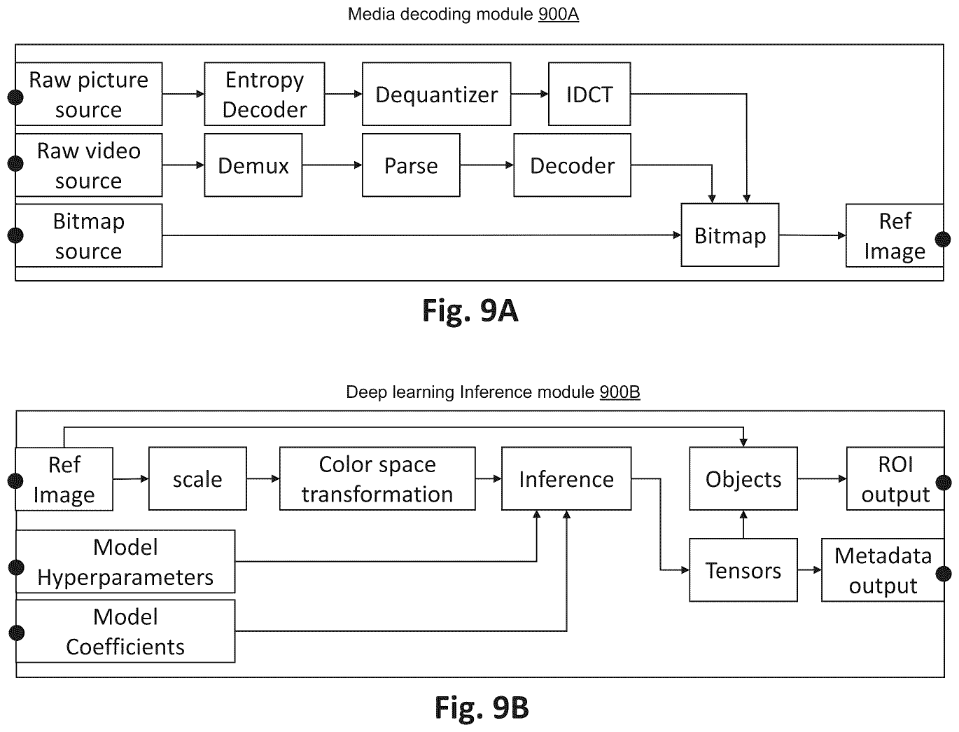

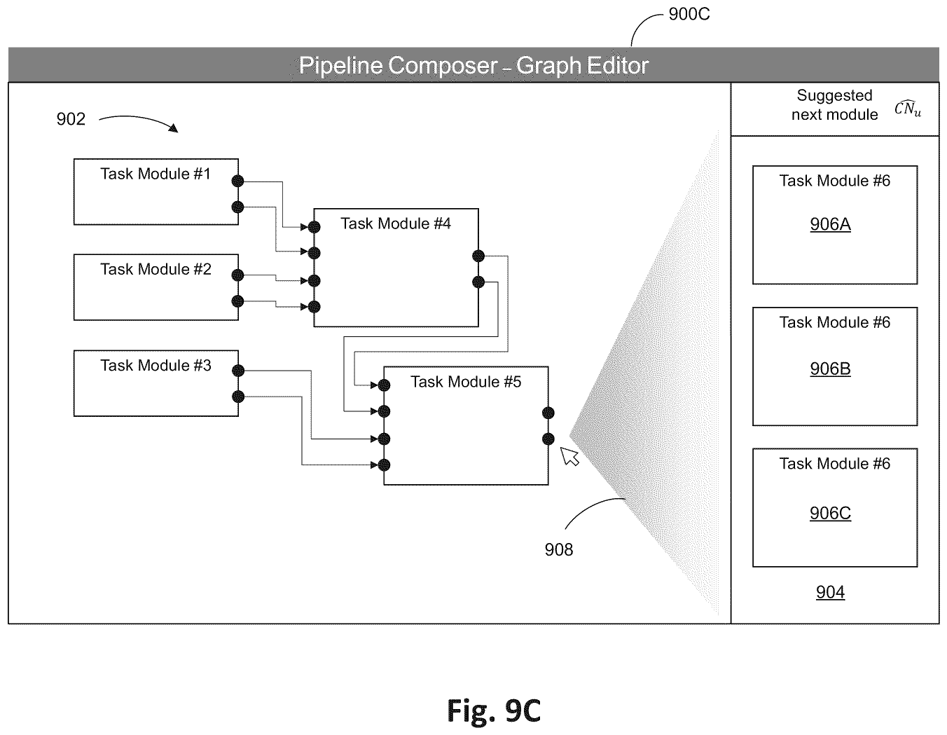

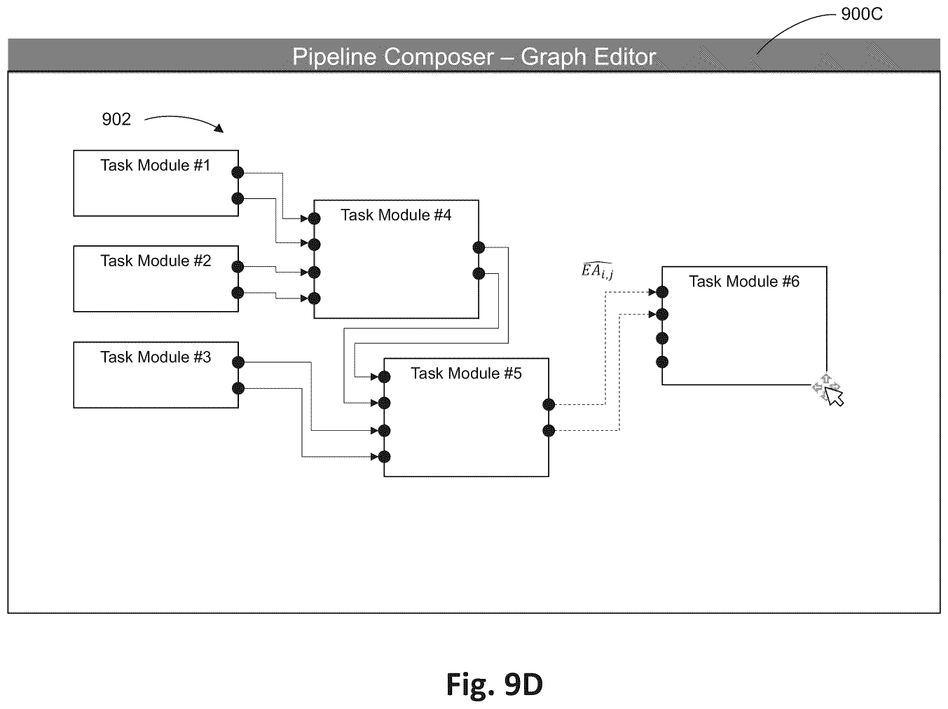

FIGS. 9A and 9B are block diagrams of examples of task components. FIG. 9A illustrates an example of a media decoding module. FIG. 9B illustrates an example of a deep learning inference module. The media decoding module 900A is an example of an input task component that would be added to the input stage of the AI pipeline. The deep learning inference module 900B is an example of an analytics or analysis task component that would be added to the analytics stage of the pipeline. Consider an example in which the user had added the media decoding module 900A to the pipeline and the component predictor model recommended the deep learning inference module 900B as the next task component. A trained connection predictor model would determine that the “Ref image” output of the media decoding module 900A would connect with the “Ref Image” input of the deep learning inference module 900B. Note that although the task components of FIGS. 9A and 9B are not shown as having standardized inputs and outputs, standardization of the IOs of all task components can significantly reduce complexity of the models.

FIG. 9C is an example of a graphical user interface displaying recommended next task components. The graphical user interface of FIG. 9C displays a graph editor of a pipeline composer in a window 900C. The pipeline 902 that the user is creating or editing is displayed in the window 900C. The existing pipeline 902 includes task modules (task components) 1-5. The AI-assisted pipeline copilot suggests one or more next task modules. In the illustrated example, suggested next task modules 906A-906C are displayed to the user (e.g., in a window or pane 904). Recommended connections to the existing pipeline can also be provided. For example, the AI-assisted pipeline copilot recommends that the task modules 906A-906C can be connected to the outputs of task module #5. The recommended connection is shown in FIG. 9C with the graphic 908, however, the recommended connections can be displayed to the user with text, graphics, or a combination of text and graphics.

FIG. 9D is an example of a graphical user interface displaying the pipeline 902

after the next task component is selected. In the illustrated example, the user selected (e.g., by dragging and dropping, double clicking, or other selection mechanism) one of the task modules 906A-906C suggested by the AI-assisted pipeline copilot. The next task component (task module #6) is then graphically added to the pipeline 902 and connected to one or more of the previously added task components. In the illustrated example, the output of task module #5 is connected to the input of task module #6.

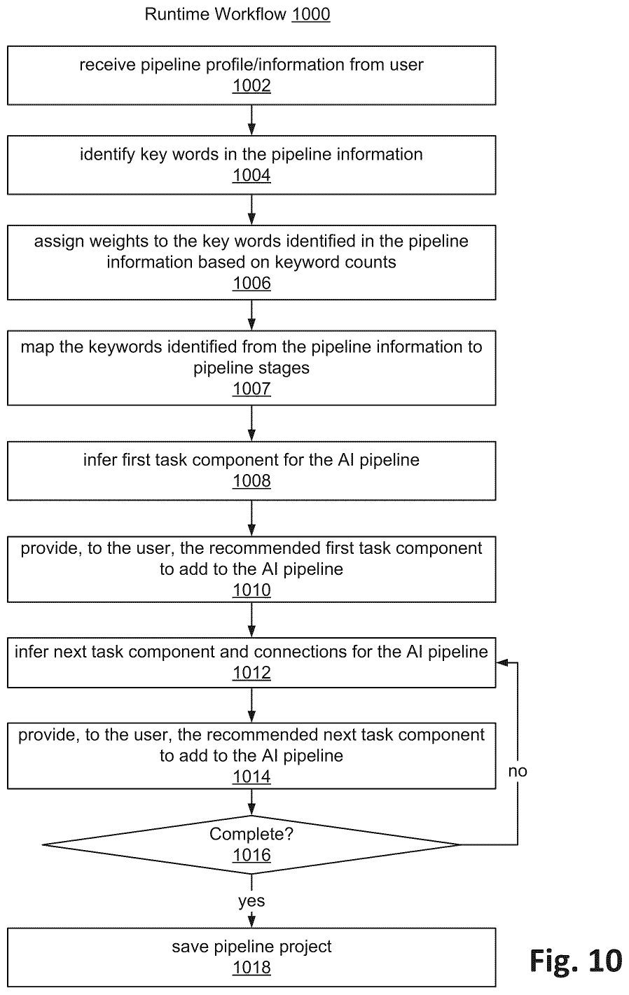

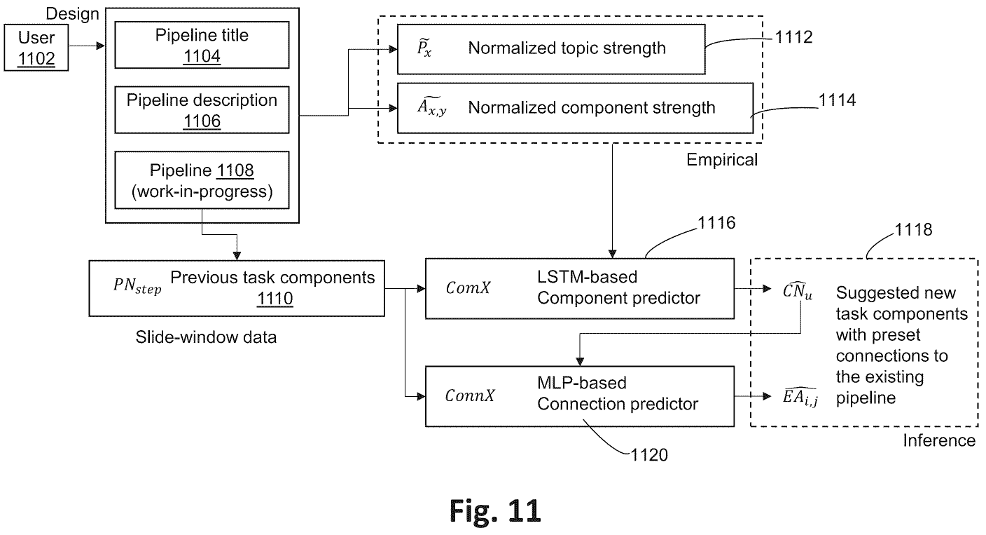

FIG. 10 is a flow chart of an example of a runtime workflow method 1000 using an AI-assisted pipeline copilot. In one example, the method 1000 can be implemented in software that is executed by one or more processors. FIG. 11 is a block diagram of an example of the runtime workflow of FIG. 10.

Referring to FIG. 10, the method 1000 begins with receiving pipeline information, such as a pipeline profile, from a user, at block 1002. In one example, the pipeline information includes or more of: pipeline tile, pipeline description, and pipeline I/Os. For example, referring to FIG. 11, the user 1102 provides a pipeline title 1104, a pipeline description 1106, and the existing pipeline 1108 as part of the project design. Referring again to FIG. 10, the method involves identifying keywords in the pipeline information, at block 1004. In one example, strengths or weights are assigned to each of the keywords identified in the pipeline information, at 1006. For example, referring to FIG. 11, normalized topic strengths 1112 are generated from the pipeline title 1104 and description 1106.

Referring again to FIG. 10, the method then involves mapping the keywords

identified from the pipeline information to pipeline stages, at block 1007. The mapping of the keywords to the pipeline stages identifies which pipeline stage a keyword is relevant for. For example, referring to FIG. 11, a normalized component strength 1114 is generated based on the identified keywords.

Referring again to FIG. 10, the method then involves inferring the first task component for the AI pipeline, at block 1008. In one example, inferring the first task component for the AI pipeline is performed with a trained LSTM model based on the keyword weights and the mapping of the keywords to the pipeline stages. The recommended first task component to add to the AI pipeline can then be provided to the user, at block 1010. For example, referring to FIG. 11, the LTSM-based component predictor 1116 receives the normalized topic strength 1112 and normalized component strength 1114 as inputs and infers the likely first task component. In the case of the first task component, the LSTM model's inference is not based on previous task components 1110 (being the first task component, there would not be previous task components 1110). The suggested new task components 1118 can then be displayed to the user with a graphical user interface.

Referring again to FIG. 10, the method then involves inferring the next task component and connections for the AI pipeline, at block 1012, and providing the recommended next task component to the user, at block 1014. For example, referring again to FIG. 11, the LSTM-based predictor 1116 receives the normalized topic strength 1112, normalized component strength 1114, and previous task components 1110 as inputs and infers the next task component to add to the AI pipeline. The previous task components 1110 and the suggested new task components are provided as inputs to the MLP-based connection predictor 1120. The MLP-based connection predictor infers likely connections of the next task components to the existing pipeline. In one example, the previous task components 1110 are provided to the models 1116 and 1120 as slide-window data. For example, as each next task component is added to the pipeline, the window or subset of previous task components provided as input the models 1116 and 1120 is adjusted so that the most recently added task components are considered by the models.

Referring again to FIG. 10, the process of inferring the next task component (at block 1012) and providing the next task component to the user (at block 1014) continues until the pipeline is complete (block 1016 YES branch). Once the pipeline is complete, the pipeline project can be saved, at block 1018, to be used as training data for the models of the AI-assisted pipeline copilot.

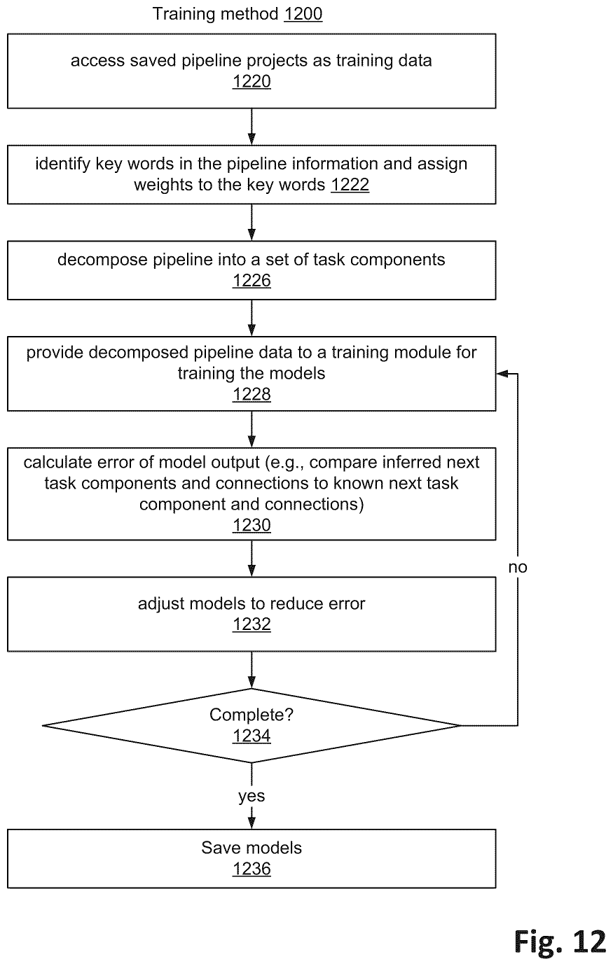

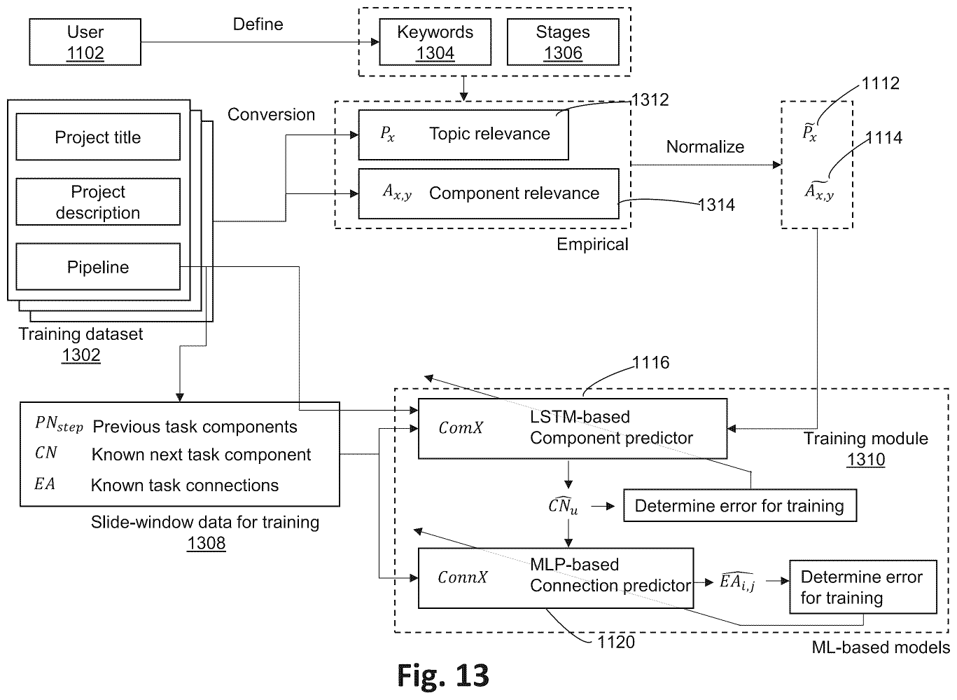

FIG. 12 is a flow chart of an example of a training method 1200. In one example, the method 1200 can be implemented in software that is executed by one or more processors. FIG. 13 is a block diagram of an example of the training method of FIG. 12.

Referring to FIG. 12, the method 1200 of training the pipeline copilot models involves using a training dataset including different pipelines created by users and the associated pipeline information. For example, the training method 1200 begins with accessing saved pipeline projects as training data, at block 1220. For example, referring to FIG. 13, a training module 1310 accesses a training dataset 1302, which includes previously created pipelines and corresponding pipeline titles and pipeline descriptions.

Referring to FIG. 12, the training method 1200 involves identifying key words in the pipeline information of the training dataset and assigning weights to the key words, at block 1222. For example, referring to FIG. 13, the user 1102 provides keywords 1304 (e.g., a list of keywords to search for in the pipeline information) and pipeline stages 1306 (e.g., available stages in the pipeline). Topic relevance 1312 can then be determined for each pipeline in the training dataset 1302. In one example, the topic relevance 1312 is represented as weights assigned to key words, which can then be normalized to generate normalized keyword weights 1112. The keywords 1304 and pipeline stages 1306 can then be used to map the keywords identified for each pipeline in the training dataset 1302. In one example, the mapping of keywords to pipeline stages is represented as component relevance 1314, which can then be normalized to generate a normalized abstraction graph 1114 that indicates which stage of the pipeline a given keyword is relevant for.

Referring again to FIG. 12, the method involves decomposing the pipelines from the training dataset into sets of task components, at block 1226. In one example, the pipelines are decomposed into a set of linked lists that include the previous N-step components (e.g., previous task components) and the N+1 component (e.g., the known next task component). The decomposed pipeline data is then provided to a training model for training the models, at 1228. For example, referring to FIG. 13, the pipelines of the training dataset 1302 are decomposed into the slide window data for training 1308, which includes previous task components, the known next task component, and known task component connections. The slide window data is provided to the training module 1310. The training module 1310 executes the model 1116 with the slide window data (e.g., previous task components), keyword weights 1112, and the keyword mapping 1114 as input. Similarly, the training module 1310 executes the model 1120 with the slide window data (e.g., previous task components) and recommended next task components from the model 1116.

Referring to FIG. 12, the method involves calculating the error of the model outputs, at 1230. In one example, calculating the model outputs involves comparing the inferred next task components and connections to the known next task component and connections. The models can then be adjusted to reduce the error in the model outputs, at block 1232. Adjusting the models can involve, for example, adjusting the weights in the model. If the error from one or both models is above an acceptable level (e.g., a predetermined threshold), the training continues with blocks 1228, 1230, and 1232. Once an acceptable error has been achieved (block 1234 YES branch), the training may be considered complete and the models are saved, at block 1236.

After the AI-assisted pipeline copilot models are trained, the models and related methods run as a runtime application (e.g., on the northbound of the GUI/Dashboard interface of a pipeline composer). In one example, as depicted in FIG. 10, every time user adds a new task component to the pipeline, the predictors mentioned above infer the best task component option (one or more) for the user to choose and accept. In one example, the AI-assisted pipeline copilot analyzes user-provided pipeline information (e.g., pipeline title, descriptions, IO sets) and the existing workflow design to produce the most useful subsequent functional blocks for users to select from. The AI-assisted pipeline copilot can help accelerate the construction of the pipeline in an intuitive way without the need for programming skills.

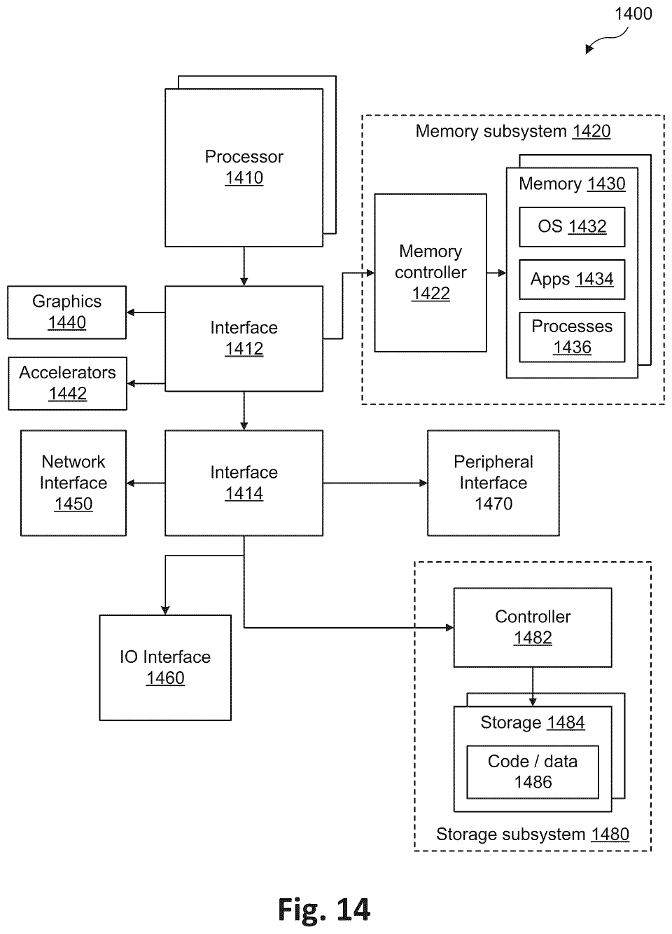

FIG. 14 depicts a compute platform 1400 such as a server or similar computing system in which techniques described herein may be implemented. Compute platform 1400 includes one or more processors 1410, which provides processing, operation management, and execution of instructions for compute platform 1400. Processor 1410 can include any type of microprocessor, central processing unit (CPU), graphics processing unit (GPU), processing core, multi-core processor or other processing hardware to provide processing for compute platform 1400, or a combination of processors. Processor 1410 controls the overall operation of compute platform 1400, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In some examples, processing may be split between a CPU and a GPU. For example, it is common to implement TensorFlow on compute platforms including a CPU and a GPU. In some examples, the CPU and GPU are separate components. In other embodiments, a CPU and GPU may be implemented in a System on a Chip (SoC) or in a multi-chip module or the like.

In one example, compute platform 1400 includes interface 1412 coupled to processor 1410, which can represent a higher speed interface or a high throughput interface for system components that needs higher bandwidth connections, such as memory subsystem 1420 or optional graphics interface components 1440, or optional accelerators 1442. Interface 1412 represents an interface circuit, which can be a standalone component or integrated onto a processor die. Where present, graphics interface 1440 interfaces to graphics components for providing a visual display to a user of compute platform 1400. In one example, graphics interface 1440 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1440 generates a display based on data stored in memory 1430 or based on operations executed by processor 1410 or both. In one example, graphics interface 1440 generates a display based on data stored in memory 1430 or based on operations executed by processor 1410 or both.

In some examples, accelerators 1442 can be a fixed function offload engine that can be accessed or used by a processor 1410. For example, an accelerator among accelerators 1442 can provide data compression capability, cryptography services such as public key encryption (PKE), cipher, hash/authentication capabilities, decryption, or other capabilities or services. In some examples, in addition or alternatively, an accelerator among accelerators 1442 provides field select controller capabilities as described herein. In some cases, accelerators 1442 can be integrated into a CPU socket (e.g., a connector to a motherboard or circuit board that includes a CPU and provides an electrical interface with the CPU). For example, accelerators 1442 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1442 can provide multiple neural networks, CPUs, processor cores, general purpose graphics processing units, or graphics processing units can be made available for use by AI or ML models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, graph neural network, or other AI or ML model. Multiple neural networks, processor cores, or graphics processing units can be made available for use by AI or ML models.

Memory subsystem 1420 represents the main memory of compute platform 1400 and provides storage for code to be executed by processor 1410, or data values to be used in executing a routine. Memory subsystem 1420 can include one or more memory devices 1430 such as read-only memory (ROM), flash memory, one or more varieties of random-access memory (RAM) such as DRAM, or other memory devices, or a combination of such devices. Memory 1430 stores and hosts, among other things, operating system (OS) 1432 to provide a software platform for execution of instructions in compute platform 1400. Additionally, applications 1434 can execute on the software platform of OS 1432 from memory 1430. Applications 1434 represent programs that have their own operational logic to perform execution of one or more functions. Processes 1436 represent agents or routines that provide auxiliary functions to OS 1432 or one or more applications 1434 or a combination. OS 1432, applications 1434, and processes 1436 provide software logic to provide functions for compute platform 1400. In one example, memory subsystem 1420 includes memory controller 1422, which is a memory controller to generate and issue commands to memory 1430. It will be understood that memory controller 1422 could be a physical part of processor 1410 or a physical part of interface 1412. For example, memory controller 1422 can be an integrated memory controller, integrated onto a circuit with processor 1410.

While not specifically illustrated, it will be understood that compute platform 1400 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, compute platform 1400 includes interface 1414, which can be coupled to interface 1412. In one example, interface 1414 represents an interface circuit, which can include standalone components and integrated circuitry. In one example, multiple user interface components or peripheral components, or both, couple to interface 1414. Network interface 1450 provides compute platform 1400 the ability to communicate with remote devices (e.g., servers or other computing devices) over one or more networks. Network interface 1450 can include an Ethernet adapter, wireless interconnection components, cellular network interconnection components, USB (universal serial bus), or other wired or wireless standards-based or proprietary interfaces. Network interface 1450 can transmit data to a device that is in the same data center or rack or a remote device, which can include sending data stored in memory. Network interface 1450 can receive data from a remote device, which can include storing received data into memory. Various embodiments can be used in connection with network interface 1450, processor 1410, and memory subsystem 1420.

In one example, compute platform 1400 includes one or more IO interface(s) 1460. IO interface 1460 can include one or more interface components through which a user interacts with compute platform 1400 (e.g., audio, alphanumeric, tactile/touch, or other interfacing). Peripheral interface 1470 can include any hardware interface not specifically mentioned above. Peripherals refer generally to devices that connect dependently to compute platform 1400. A dependent connection is one where compute platform 1400 provides the software platform or hardware platform or both on which operation executes, and with which a user interacts.

In one example, compute platform 1400 includes storage subsystem 1480 to store data in a nonvolatile manner. In one example, in certain system implementations, at least certain components of storage 1480 can overlap with components of memory subsystem 1420. Storage subsystem 1480 includes storage device(s) 1484, which can be or include any conventional medium for storing large amounts of data in a nonvolatile manner, such as one or more magnetic, solid state, or optical based disks, or a combination. Storage 1484 holds code or instructions and data 1486 in a persistent state (i.e., the value is retained despite interruption of power to compute platform 1400). Storage 1484 can be generically considered to be a “memory.” although memory 1430 is typically the executing or operating memory to provide instructions to processor 1410. Whereas storage 1484 is nonvolatile, memory 1430 can include volatile memory (i.e., the value or state of the data is indeterminate if power is interrupted to compute platform 1400). In one example, storage subsystem 1480 includes controller 1482 to interface with storage 1484. In one example, controller 1482 is a physical part of interface 1414 or processor 1410 or can include circuits or logic in both processor 1410 and interface 1414.

Volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random-Access Memory), or some variant such as Synchronous DRAM (SDRAM). A memory subsystem as described herein can be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2. JESD229-2 originally published by JEDEC in August 2014, HBM (High Bandwidth Memory, JESD325, originally published by JEDEC in October 2013, DDR5 (DDR version 5), LPDDR5, HBM2E, HBM3, and HBM-PIM, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can include a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also include a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In an example. compute platform 1400 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Peripheral Component Interconnect express (PCIe), Intel® QuickPath Interconnect (QPI), Intel® Ultra Path Interconnect (UPI), Intel® On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

In addition to systems with CPUs, the teaching and principles disclosed herein may be applied to Other Processing Units (collectively termed XPUs) including one or more of Graphic Processor Units (GPUs) or General Purpose GPUs (GP-GPUs), Tensor Processing Units (TPUs), Data Processor Units (DPUs), Infrastructure Processing Units (IPUs), Artificial Intelligence (AI) processors or AI inference units and/or other accelerators, FPGAs and/or other programmable logic (used for compute purposes), etc. While some of the diagrams herein show the use of CPUs, this is merely exemplary and non-limiting. Generally, any type of XPU may be used in place of a CPU in the illustrated embodiments. Moreover, as used in the following claims, the term “processor” is used to generically cover CPUs and various forms of XPUs.

As will be recognized by those skilled in the art, techniques described herein may employ a single machine (compute platform, server, compute node, etc.) or may employ distributed set of machines. Accordingly, a system used to implement the techniques described and illustrated herein may include compute resources (e.g., a processor, memory, etc.) for a single compute platform/server/node or a set of interconnected compute platforms, servers, or nodes. Moreover, processes may be distributed over a set of compute resources in a single machine, such as distributed across CPU cores in a multi-core processor, distributed between a CPU and a GPU, distributed among multiple GPUs, or more generally distributed across multiple processors comprising CPUs and XPUs.

Examples of AI-assisted context-aware pipeline creation follow.

Example 1: A method including: receiving pipeline information from a user for an artificial intelligence (AI) pipeline, identifying key words in the pipeline information, determining one or more recommended next task components to add to the AI pipeline based on:

a mapping of the key words to AI pipeline stages and one or more previous task components added to the AI pipeline, and providing the one or more recommended next task components to the user.

Example 2: The method of example 1, further including assigning weights to the key words identified in the pipeline information based on keyword counts, wherein determining the one or more recommended next task components to add to the AI pipeline is further based on: the weights of the key words.

Example 3: The method of examples 1 or 2, wherein: determining the one or more recommended next task components includes processing, with a long short-term memory prediction model: the weights of the key words, the mapping of the key words to AI pipeline stages, and the one or more previous task components added to the AI pipeline.

Example 4: The method of any of examples 1-3, wherein output of the long short-term memory (LTSM) model includes confidence levels for the one or more recommended next task components.

Example 5: The method of any of examples 1-4, wherein: the one or more recommended next task components are based on all previous task components added to the AI pipeline.

Example 6: The method of any of examples 1-5, wherein: the one or more recommended next task components are based on a predetermined number of previous task components added to the AI pipeline.

Example 7: The method of any of examples 1-6, further including: determining estimated connection strengths between inputs/outputs (I/Os) of the one or more recommended next task components and I/Os of each of the one or more previous task components, and providing one or more recommended connections between the I/Os of the one or more recommended next task components and the I/Os of one or more of the previous task components based on the estimated connection strengths.

Example 8: The method of any of examples 1-7, wherein: determining the estimated connection strengths includes processing, with a multi-layer perceptron (MLP) model, the one or more recommended next task components and the one or more previous task components.

Example 9: The method of any of examples 1-8, further including: training the MLP model with a training dataset, the training dataset including: connectivity between task components of previously completed AI pipelines and corresponding pipeline information.

Example 10: The method of any of examples 1-9, further including: training the LTSM model with a training dataset, the training dataset including: previously completed AI pipelines and corresponding pipeline information.

Example 11: The method of any of examples 1-10, wherein: the pipeline information includes one or more of: a pipeline title, a pipeline description, and inputs and outputs (I/Os) for the pipeline.

Example 12: The method of any of examples 1-11, wherein providing the one or

more recommended next task components includes displaying the one or more recommended next task components with a graphical user interface (GUI).

Example 13: The method of any of examples 1-12, further including: displaying one or more recommended connections between inputs/outputs (I/Os) of the one or more recommended next task component and I/Os one or more previous task components.

Example 14: A non-transitory machine-readable medium having instructions stored thereon configured to be executed on one or more processors to perform a method in accordance with any of examples 1-13.

Example 15: A computing system including: one or more processors, memory, coupled to the one or more processors, having instructions stored therein configured to be executed on at least one of the one or more processors to enable the system to: receive pipeline information from a user for an artificial intelligence (AI) pipeline, identify key words in the pipeline information, determine one or more recommended next task components to add to the AI pipeline based on: a mapping of the key words to AI pipeline stages and one or more previous task components added to the AI pipeline, and provide the one or more recommended next task components to the user.

Example 16: The computing system of example 15, wherein the instructions when executed cause the system to perform a method in accordance with any of examples 1-13.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted: thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine-readable storage medium can cause a machine to perform the functions or operations described and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow:

What is claimed is:

1. A non-transitory machine-readable medium having instructions stored thereon configured to be executed on one or more processors to perform a method comprising:
receiving pipeline information from a user for an artificial intelligence (AI) pipeline;
identifying key words in the pipeline information;
determining one or more recommended next task components to add to the AI pipeline based on: a mapping of the key words to AI pipeline stages and one or more previous task components added to the AI pipeline; and
providing the one or more recommended next task components to the user.

2. The non-transitory machine-readable medium of claim 1, further comprising:
assigning weights to the key words identified in the pipeline information based on keyword counts;
wherein determining the one or more recommended next task components to add to the AI pipeline is further based on: the weights of the key words.

3. The non-transitory machine-readable medium of claim 2, wherein:
determining the one or more recommended next task components includes:
processing, with a long short-term memory prediction model: the weights of the key words, the mapping of the key words to AI pipeline stages, and the one or more previous task components added to the AI pipeline.

4. The non-transitory machine-readable medium of claim 3, wherein:
output of the long short-term memory (LTSM) model includes confidence levels for the one or more recommended next task components.

5. The non-transitory machine-readable medium of claim 1, wherein:
the one or more recommended next task components are based on all previous task components added to the AI pipeline.

6. The non-transitory machine-readable medium of claim 1, wherein:
the one or more recommended next task components are based on a predetermined number of previous task components added to the AI pipeline.

7. The non-transitory machine-readable medium of claim 1, further comprising:
determining estimated connection strengths between inputs/outputs (I/Os) of the one or more recommended next task components and I/Os of each of the one or more previous task components; and
providing one or more recommended connections between the I/Os of the one or more recommended next task components and the I/Os of one or more of the previous task components based on the estimated connection strengths.

8. The non-transitory machine-readable medium of claim 7, wherein:
determining the estimated connection strengths comprises:
processing, with a multi-layer perceptron (MLP) model, the one or more recommended next task components and the one or more previous task components.

9. The non-transitory machine-readable medium of claim 8, further comprising:
training the MLP model with a training dataset, the training dataset including:
connectivity between task components of previously completed AI pipelines and corresponding pipeline information.

10. The non-transitory machine-readable medium of claim 4, further comprising:
training the LTSM model with a training dataset, the training dataset including:
previously completed AI pipelines and corresponding pipeline information.

11. The non-transitory machine-readable medium of claim 1, wherein:
the pipeline information includes one or more of: a pipeline title, a pipeline description, and inputs and outputs (I/Os) for the pipeline.

12. The non-transitory machine-readable medium of claim 1, wherein:
providing the one or more recommended next task components includes:
displaying the one or more recommended next task components with a graphical user interface (GUI).

13. The non-transitory machine-readable medium of claim 12, further comprising:
displaying one or more recommended connections between inputs/outputs (I/Os) of the one or more recommended next task component and I/Os one or more previous task components.

14. A computing system comprising:
one or more processors,
memory, coupled to the one or more processors, having instructions stored therein configured to be executed on at least one of the one or more processors to enable the system to:
receive pipeline information from a user for an artificial intelligence (AI) pipeline;
identify key words in the pipeline information;
determine one or more recommended next task components to add to the AI pipeline based on: a mapping of the key words to AI pipeline stages and one or more previous task components added to the AI pipeline; and
provide the one or more recommended next task components to the user.

15. The computing system of claim 14, wherein execution of the instructions enables the system to:
assign weights to the key words identified in the pipeline information based on keyword counts;
wherein determination of the one or more recommended next task components to add to the AI pipeline is further based on: the weights of the key words.

16. The computing system of claim 15, wherein execution of the instructions to determine a recommended next task component enables the system to:
process, with a long short-term memory prediction model: the weights of the key words, the mapping of the key words to AI pipeline stages, and the one or more previous task components added to the AI pipeline.

17. The computing system of claim 16, wherein:
output of the long short-term memory (LTSM) model includes confidence levels for the one or more recommended next task components.

18. The computing system of claim 14, wherein:
the one or more recommended next task components are based on a predetermined number of previous task components added to the AI pipeline.

19. The computing system of claim 14, wherein execution of the instructions enables the system to:
determine estimated connection strengths between inputs/outputs (I/Os) of the one or more recommended next task components and I/Os of each of the one or more previous task components; and
provide one or more recommended connections between the I/Os of the one or more recommended next task components and the I/Os of one or more of the previous task components based on the estimated connection strengths.

20. The computing system of claim 19, wherein execution of the instructions to determine the estimated connection strengths enables the system to:
process, with a multi-layer perceptron (MLP) model, the one or ore recommended next task components and the one or more previous task components.

21. The computing system of claim 20, wherein execution of the instructions enables the system to:
train the MLP model with a training dataset, the training dataset including: connectivity between task components of previously completed AI pipelines and corresponding pipeline information.

22. The computing system of claim 17, wherein execution of the instructions enables the system to:
train the LTSM model with a training dataset, the training dataset including: previously completed AI pipelines and corresponding pipeline information.

23. The computing system of claim 14, wherein:
the pipeline information includes one or more of: a pipeline title, a pipeline description, and inputs and outputs (I/Os) for the pipeline.

24. The computing system of claim 15, wherein execution of the instructions to provide the one or more recommended next task components enables the system to:
display the one or more recommended next task components with a graphical user interface (GUI).

25. The computing system of claim 24, wherein execution of the instructions enables the system p1 display one or more recommended connections between inputs/outputs (I/Os) of the one or more recommended next task components and I/Os one or more previous task components.
